(19) United States
(12) Patent Application Publication
(10) Pub. No.: US 2023/0275232 A1
(43) Pub. Date: Aug. 31, 2023

(54) BINDER FOR SILICON-BASED ANODE MATERIAL

(71) Applicant: SOLVAY SPECIALTY POLYMERS ITALY S.P.A., Bollate (Milano) (IT)

(72) Inventors: Maurizio Biso, Milano (IT); Libero Damen, Arese (IT); William R. Tilford, Stone Mountain, GA (US)

(73) Assignee: SOLVAY SPECIALTY POLYMERS ITALY S.P.A., Bollate (Milano) (IT)

(21) Appl. No.: 18/016,404

(22) PCT Filed: Jul. 8, 2021
(86) PCT No.: PCT/EP2021/069065

§ 371 Date: Jan. 16, 2023

Related U.S. Application Data
(60) Provisional application No. 63/052,924, filed on Jul. 16, 2020.

(30) Foreign Application Priority Data
Nov. 30, 2020 (EP) 20210786.8

(51) Int. Cl. H01M 4/62; H01M 10/0525; H01M 4/583; H01M 4/38

(52) U.S. Cl. CPC H01M 4/622; H01M 10/0525; H01M 4/583; H01M 4/386; H01M 4/625; H01M 2004/027

(57) ABSTRACT

The present invention generally relates to blends of poly acrylic acid (PAA) and polyacrylamide (PAM) and their use as binders in negative electrodes for lithium ion batteries.

### CROSS-REFERENCE TO RELATED APPLICATIONS

This application claims priority to U.S. provisional application No. 63/052,924 filed on Jul. 16, 2020 and to European application No. 20210786.8 filed on Nov. 30, 2020, the whole content of this application being incorporated herein by reference for all purposes.

### TECHNICAL FIELD

The present invention generally relates to blends of poly acrylic acid (PAA) and polyacrylamide (PAM) and their use as binders in negative electrodes for lithium ion batteries.

### BACKGROUND ART

Current lithium ion batteries are limited in their storage of electrical charge by the capacity of the negative electrode. There is a general view that the most direct path to creating the next generation of energy storage systems is to significantly increase the storage capacity of lithium ion batteries by incorporating silicon into the graphite negative electrode. Silicon is able to reversibly store far more lithium than graphite, and presently small quantities are blended into the negative electrode resulting in marked capacity increases, but current binders only accommodate limited silicon loading (up to 10 wt. %) before battery lifetime is significantly reduced because of reduced charge cycle stability. Further capacity improvements are limited because the silicon particles swell and shrink significantly as a result of the large quantities of lithium stored and released during charging and discharging. This produces mechanical stress that results in cracking and particle attrition, impeding the path of ions in the cell, which in turn diminishes battery performance with battery cycling.

There is much activity presently dedicated to development of new binders for silicon-containing anodes to enable higher energy density storage.

The binder, typically an organic polymer, serves as the connective matrix that maintains contact between active materials throughout the anode layer and with the current collector onto which the anode is deposited during fabrication.

There are many approaches being pursued to develop next generation binders to accommodate silicon anodes.

It is generally accepted that chemical functionalities conducive to favorable surface interactions with both the active material and current collector substrate are necessary. Furthermore, chemical compatibility with the liquid electrolyte and other additives are a prerequisite to any binder irrespective of active material compositions. To overcome the specific challenges associated with silicon, one approach is to create a self-healing mechanism within the binder matrix by incorporating weak bonding interactions that enable a degree of reversibility, where these labile bonds can be disrupted under stress but reformed upon relaxation without irreparable damage to the active material particles and to the electrode prepared thereof, due to loss of contact among particles that results in an inactive electrode.

Carboxymethylcellulose (CMC) is a well-documented example of this where hydrogen bonding occurs between pendant acid groups and silanol groups on the silicon surface.

There are multiple polycarboxylate binders and derivatives being pursued, including polyacrylic acids, polyamic acids, polyacrylamides, and other hydrogen bonding structures.

Miranda, A. et al (“A Comprehensive Study of Hydrolyzed Polyacrylamide as a Binder for Silicon Anodes” Appl. Mater. Interfaces, 2019, 11, 44090-44100) disclose the use of partially hydrolyzed polyacrylamide in the preparation of composite silicon anodes having good adhesion, high strength and high electrochemical storage capacity.

Despite the current strategies to prevent degradation of silicon-rich anodes, there seems to be a limit to which they are effective, with no clear breakthrough yet reaching the higher levels of silicon needed to achieve meaningful advancements in the field. There are numerous disclosures of mixed binder systems to leverage cooperative effects between molecules to boost binder performance.

U.S. Pat. No. 6,399,246 (Eveready Battery Company Inc.) is generally directed to a water soluble binder containing polyacrylamide and at least one copolymer selected from carboxylated styrene-butadiene copolymer and styrene-acrylate copolymer.

New binders based on polyacrylic acid (PAA), and carboxymethyl cellulose with styrene butadiene (CMC-SBR) have been studied, however they are still too brittle and have been found to create failure points within the binder matrix itself.

With respect to polycarboxylates, especially polyacrylic acids, it is also well documented that there are advantages to first convert them to lithium salts by neutralizing with a base such as lithium hydroxide. This is primarily done to avoid sequestration of lithium ions by the free acid groups in the cell, which can diminish the initial capacity.

The Applicant has unexpectedly found that the combination of two materials in a single binder formulation in low cost and environmentally-friendly solvents such as water, specifically a mixture of polyacrylamide (PAM) and polyacrylic acid metal salt (PAA-Salt), may be used as a binder for electrodes, especially for silicon rich anodes, exhibiting high cycle stability and electrochemical stability.

### SUMMARY OF INVENTION

It is an object of the invention an aqueous electrode-forming composition [composition (C)] for use in the preparation of electrodes for electrochemical devices, characterized by comprising:
a) a binder composition [binder (B)] comprising:
   aᵢ) at least one polyacrylamide (PAM) having a number average molecular weight (Mn) of at most 1600000 g/mol, and aᵢᵢ) at least one polyacrylic acid metal salt (PAA-Salt),
b) an electrode active material,
c) an aqueous solvent, and
d) optionally at least one electroconductivity-imparting additive.

Another object of the invention is a process for preparing an electrode [electrode (E)], said process comprising:
(i) providing a metal substrate having at least one surface;
(ii) providing a composition (C) as above defined;
(iii) applying the composition (C) provided in step (ii) onto the at least one surface of the metal substrate provided in step (i), thereby providing an assembly comprising a metal substrate coated with said composition (C) onto the at least one surface;
(iv) drying the assembly provided in step (iii);
(v) submitting the dried assembly obtained in step (iv) to a compression step to obtain the electrode (E) of the invention.

In a further aspect, the present invention pertains to the electrode [electrode (E)] obtainable by the process of the invention.

In still a further object, the present invention pertains to an electrochemical device comprising at least one electrode (E) of the present invention.

### DETAILED DESCRIPTION

In the context of the present invention, the term “percent by weight” (wt. %) indicates the content of a specific component in a mixture, calculated as the ratio between the weight of the component and the total weight of the mixture. When referred to the total solid content (TSC) of a liquid composition, weight percent (wt. %) indicates the ratio between the weight of all non-volatile ingredients in the liquid.

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

As known in the art, an electrode forming composition is a composition of matter, typically a fluid composition, wherein solid components are dissolved or dispersed in a liquid, which can be applied onto a metallic substrate and subsequently dried thus forming an electrode wherein the metallic substrate acts as current collector. Electrode forming compositions typically comprise at least an electro active material and at least a binder.

The electrode-forming composition [composition (C)] of the present invention comprises at least one polyacrylamide (PAM) and at least one metal salt of polyacrylic acid (PAA-Salt), which function as a binder.

The preparation of an electrode-forming composition comprises the preparation of an aqueous binder composition to be then added with the powdery electrode material.

The Binder (B)

The binder composition [binder (B)] is comprised of at least one polyacrylamide (PAM) and at least one metal salt of polyacrylic acid (PAA-Salt).

While not being bound to any particular theory, it is believed that an attractive interaction between metal ions of the PAA-Salt and the amide functionality of the PAM occurs. The two polymers PAM and PAA-Salt are bonded via metal ion bridging between the carboxylates of PAA and amide groups of PAM. The attractive force of this ion-dipole interaction creates a co-polymer network strong enough to bind the anode matrix, but dissociate under stress without damaging the active material. These dynamic linkages within this system offer a new type of self-repair mechanism uniquely suited for lithium-ion battery applications.

Polyacrylamide (PAM) is a water-soluble polymer, which is believed to improve the smoothness and uniformity of the binder mixture, thereby positively affecting the rheological properties of the same.

PAM includes any polymer or copolymer of acrylamide and methacrylamide-based monomers, including, acrylamide, n-methylolacrylamide, n-butoxymethylacrylamide, methacrylamide, n-methylolmethacrylamide and n-butoxymethylmethacrylamide. Useful monomers that can be used to form copolymers with acrylamide-based monomers include, for example, unsaturated carboxylic acid-based monomers.

In some embodiments, the PAM has a number average molecular weight (Mn) of at least 2000 g/mol, preferably at least 10000 g/mol, more preferably at least 150000 g/mol. In some embodiments, the PAM has a number average molecular weight (Mn) of at most 1600000 g/mol.

Processes for preparing a suitable PAM are well known and PAM of different number average molecular weights are commercially available.

Polyacrylic acid (PAA) includes any polymer or copolymer of acrylic acid or methacrylic acid or their derivatives where at least about 50 mole %, at least about 60 mole %, at least about 70 mole %, at least about 80 mole %, or at least about 90 mole % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, hydroxyl(meth)alkylacrylates, and the like.

Homopolymers and copolymers of acrylic and methacrylic acid that are useful in this invention can have a number average molecular weight (Mn) of at least 2000 g/mol, preferably at least 90000 g/mol, more preferably at least 250000 g/mol. In some embodiments, the PAA-Salt has a number average molecular weight (Mn) of at most 4000000 g/mol, preferably at most 1250000 g/mol, more preferably at most 450000 g/mol.

Methods of preparing a suitable PAA-Salt are well known in the art.

The PAA-Salt used in the present invention can be prepared from the corresponding polyacrylic acid (PAA) by neutralizing acid groups with a salt [salt (S)] including a monovalent cation, preferably an alkaline metal salt in a suitable solvent.

Binder (B) can include one or more than one PAA-Salt as above defined.

The salt (S) can be any salt capable of neutralizing the acid groups. In some embodiments, the salt (S) is a lithium salt selected from the group consisting of lithium carbonate, lithium hydroxide, lithium bicarbonate, and combinations thereof, preferably lithium carbonate. In some embodiments, the lithium salt is free of lithium hydroxide.

The solvent for use in the step of salification of PAA to provide PAA-Salt can be any solvent capable of dissolving the salt (S) and the resulting PAA-Salt. Preferably, the solvent is selected from at least one of an aqueous solvent, such as water, NMP, and alcohols, such as, for example, methanol, isopropanol, and ethanol. Most preferably, the solvent is an aqueous solvent. Still more preferably the solvent is water.

Preferably the content of the salt (S) in the solvent ranges from 0.5 to 10 wt. %, preferably from 1 to 5 wt. %, based on the total weight of the solvent and the salt (S).

In some embodiments wherein the salt (S) is a lithium salt, the concentration of the lithium salt in the solvent provides at least 0.25 eq, 0.5 eq, 1 eq, 1.5 eq, 2 eq, 2.5 eq, 3 eq, 4, eq of lithium to acid groups. In some embodiments, the concentration of the lithium salt in the solvent provides at most 5 eq, preferably at most 4, eq of lithium to acid groups.

The content of PAA-Salt in the solution after salification, based on the total weight of the solvent and the PAA-Salt, ranges from 0.5 to 40 wt %, preferably from 5 to 30 wt %, more preferably 10 to 30 wt %.

The PAA-Salt can be isolated as a solid from the solution after salification and optionally stored for later use. The solid PAA-Salt can also be dissolved (or re-dissolved) in water to prepare the electrode-forming composition described below. Preferably, however, the solution including the PAA-Salt after salification is an aqueous solution that can be used directly, optionally with further dilution with water, in preparing binder composition as described below.

In a preferred embodiment, a lithium salt of PAA (Li-PAA) was prepared by adding an amount of LiOH to fully neutralize an aqueous solution containing about 10 wt. % PAA. The resulting solution had a pH in the range of 6.5 to 7.5 and contained approximately 10 wt. % of Li-PAA.

The PAA-Salt/PAM binder [binder (B)] can suitably be prepared as solution in aqueous solvent by mixing various amounts of PAA-Salt, as solid powder or as solution obtained as above described, and PAM, as solid powder or as solution in an aqueous solvent.

The binders of this invention are advantageously employed in an aqueous binder solution comprising an aqueous solvent, preferably water, at least one PAM and at least one PAA-Salt. The expression “solution” as used herein is meant to encompass true solutions in which the polymers are uniformly dispersed at the molecular level, as well as colloidal solutions.

The binder (B) in the form of aqueous solution as above detailed comprises the PAA-Salt/PAM mixture in an amount ranging from 1 and 30 wt. parts, particularly 5-10 wt. parts, in 100 wt. parts of aqueous solvent.

The preferred amount of PAM to PAA-Salt in binder (B) is from about 3:1 to about 1:3, more preferably from about 2:1 to about 1:2, on a dry weight basis.

The Electrode-Forming Composition [Composition (C)]

The amount of binder (B) which may be used in the electrode-forming composition (C) is subject to various factors. One such factor is the surface area and amount of the active material, and the surface area and amount of any electroconductivity-imparting additive which are added to the electrode-forming composition. These factors are believed to be important because the binder particles provide bridges between the conductor particles and conductive material particles, keeping them in contact.

The electrode forming composition [composition (C)] of the present invention includes one or more electrode active material. For the purpose of the present invention, the term “electrode active material” is intended to denote a compound that is able to incorporate or insert into its structure, and substantially release therefrom, alkaline or alkaline-earth metal ions during the charging phase and the discharging phase of an electrochemical device. The electrode active material is preferably able to incorporate or insert and release lithium ions.

The nature of the electrode active material in the electrode forming composition (C) of the invention depends on whether said composition is used in the manufacture of a negative electrode (anode) or a positive electrode (cathode).

In the case of forming a positive electrode for a Lithium-ion secondary battery, the electrode active material may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1) and spinel-structured LiMn₂O₄.

As an alternative, still in the case of forming a positive electrode for a Lithium-ion secondary battery, the electrode active material may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electrode active material in the case of forming a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electrode active material is a phosphate-based electro-active material of formula Li(FeₓMn₁₋ₓ)PO₄ wherein 0≤x≤1, wherein x is preferably 1 (that is to say, lithium iron phosphate of formula LiFePO₄).

In the case of forming a negative electrode for a Lithium-ion secondary battery, the electrode active material may preferably comprise one or more carbon-based materials and/or one or more silicon-based materials.

In some embodiments, the carbon-based materials may be selected from graphite, such as natural or artificial graphite, graphene, or carbon black. These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide.

More particularly, the silicon-based compound may be silicon oxide or silicon carbide.

When present in the electrode active material, the silicon-based compounds are comprised in an amount ranging from 1 to 60% by weight, preferably from 5 to 30% by weight with respect to the total weight of the electro active compounds.

One or more optional electroconductivity-imparting additives may be added in order to improve the conductivity of a resulting electrode made from the composition of the present invention. Conducting agents for batteries are known in the art.

Examples thereof may include: carbonaceous materials, such as carbon black, graphite fine powder, carbon nanotubes, graphene, or fiber, or fine powder or fibers of metals such as nickel or aluminum. The optional conductive agent is preferably carbon black. Carbon black is available, for example, under the brand names, Super P® or Ketjenblack®.

When present, the conductive agent is different from the carbon-based material described above.

The amount of optional conductive agent is preferably from 0 to 30 wt. % of the total solids in the electrode forming composition. In particular, for cathode forming compositions the optional conductive agent is typically from 0 wt. % to 10 wt. %, more preferably from 0 wt. % to 5 wt. % of the total amount of the solids within the composition.

For anode forming compositions which are free from silicon based electro active compounds the optional conductive agent is typically from 0 wt. % to 5 wt. %, more preferably from 0 wt. % to 2 wt. % of the total amount of the solids within the composition, while for anode forming compositions comprising silicon based electro active compounds it has been found to be beneficial to introduce a larger amount of optional conductive agent, typically from 0.5 to 30 wt. % of the total amount of the solids within the composition.

The total solid content (TSC) of the composition (C) of the present invention is typically comprised between 15 and 70 wt. %, preferably from 40 to 60 wt. % over the total weight of the composition (C). The total solid content of the composition (C) is understood to be cumulative of all non-volatile ingredients thereof, notably including PAA-Salt, PAM, the electrode active material and any solid, non-volatile additional additive.

When the aqueous binder solution is prepared separately and subsequently combined with an electrode active material and optional conductive material and other additives to prepare composition (C), an amount of water sufficient to create a stable solution is employed. The amount of water used may range from the minimum amount needed to create a stable solution to an amount needed to achieve a desired total solid content in an electrode mixture after the active electrode material, optional conductive material, and other solid additives have been added.

The Electrode (E)

The electrode-forming composition (C) of the invention can be used in a process for the manufacture of an electrode [electrode (E)], said process comprising:
(i) providing a metal substrate having at least one surface;
(ii) providing an electrode-forming composition [composition (C)] as above defined;
(iii) applying the composition (C) provided in step (ii) onto the at least one surface of the metal substrate provided in step (i), thereby providing an assembly comprising a metal substrate coated with said composition (C) onto the at least one surface;
(iv) drying the assembly provided in step (iii);
(v) submitting the dried assembly obtained in step (iv) to a compression step to obtain the electrode (E) of the invention.

The metal substrate is generally a foil, mesh or net made from a metal, such as copper, aluminum, iron, stainless steel, nickel, titanium or silver.

Under step (iii) of the process of the invention, the electrode forming composition (C) is applied onto at least one surface of the metal substrate typically by any suitable procedures such as casting, printing and roll coating.

Optionally, step (iii) may be repeated, typically one or more times, by applying the electrode forming composition (C) provided in step (ii) onto the assembly provided in step (iv).

Under step (iv) of the process of the invention, drying may be performed either under atmospheric pressure or under vacuum. Alternatively, drying may be performed under modified atmosphere, e.g. under an inert gas, typically exempt notably from moisture (water vapour content of less than 0.001% v/v).

The drying temperature will be selected so as to effect removal by evaporation of the aqueous medium from the electrode (E) of the invention.

In step (v), the dried assembly obtained in step (iv) is submitted to a compression step such as a calendaring process, to achieve the target porosity and density of the electrode (E) of the invention.

Preferably, the dried assembly obtained at step (iv) is hot pressed, the temperature during the compression step being comprised from 25° C. and 130° C., preferably being of about 60° C.

Preferred target density for electrode (E) is comprised between 1.4 and 2 g/cc, preferably at least 1.55 g/cc. The density of electrode (E) is calculated as the sum of the product of the densities of the components of the electrode multiplied by their mass ratio in the electrode formulation.

In a further aspect, the present invention pertains to the electrode [electrode (E)] obtainable by the process of the invention.

Therefore the present invention relates to an electrode (E)comprising:
a metal substrate having at least one surface, and
directly adhered onto at least one surface of said metal substrate, at least one layer consisting of a composition comprising:
a) a binder composition [binder (B)] comprising:
   aᵢ) at least one polyacrylamide (PAM) and
   aᵢᵢ) at least one polyacrylic acid metal salt (PAA-Salt),
b) an electrode active material,
c) an aqueous solvent, and
d) optionally at least one electroconductivity-imparting additive.

The composition directly adhered onto at least one surface of said metal substrate corresponds to the electrode forming composition (C) of the invention wherein the aqueous solvent has been at least partially removed during the manufacturing process of the electrode, for example in step (iv) (drying) and/or in the compression step (v). Therefore all the preferred embodiments described in relation to the electrode forming compositions (C) of the invention are also applicable to the composition directly adhered onto at least one surface of said metal substrate, in electrodes of the invention, except for the aqueous medium removed during the manufacturing process.

In a preferred embodiment of the present invention, the electrode (E) is a negative electrode. More preferably, the negative electrode comprises a silicon based electro active material.

In a further preferred embodiment, the present invention relates to a negative electrode comprising, based on the total weight of the electrode:
0.5 to 15 wt. %, preferably 0.5 to 10 wt. % of the binder (B),
45 to 95 wt. %, preferably 70 to 90 wt. % of the carbon-based material,
3 to 50 wt. %, preferably 10 to 50 wt. % of the silicon-based material, and
0 to 5 wt. %, preferably 0.5 to 2.5 wt. %, more preferably about 1 wt. % of the electroconductivity-imparting additive.

The electrode (E) of the invention is particularly suitable for use in electrochemical devices, in particular in secondary batteries.

The secondary battery of the invention is preferably an alkaline or an alkaline-earth secondary battery.

The secondary battery of the invention is more preferably a lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### EXPERIMENTAL SECTION

### Materials and Methods

Polyacrylic acid (PAA) (Mn: 250000) available from Sigma-Aldrich;
Polyacrylamide (PAM) (Mn: 150000) available from Sigma-Aldrich;
Lithium hydroxide available from Sigma-Aldrich;
Silicon oxide, KSC-1064 commercially available from Shin-Etsu, theoretical capacity is about 2100 mAh/g;
Graphite, ACTILION 2 from Imerys S.A;
Carbon black, available as SC45 from Imerys S.A;
Carboxymethylcellulose (CMC), available as MAC 500LC from Nippon Paper;
Styrene-Butadiene Rubber (SBR) suspension (40 wt. % in water), available as Zeon® BM-480B from ZEON Corporation;
Electrolyte mixture of LiPF₆ 1M in EC/DMC 1/1 v/v with 2% wt. VC and 10% wt. F1EC, from Solvionic.

General Procedure for Preparation of Water Solutions of Li-PAA

PAA 35 wt. % (71.5 grams) was diluted with deionized water (178.5 grams) mixing in a beaker with magnetic stir plate to obtain 250 grams at 10 wt. %. LiOH (5 grams) was slowly added to the solution obtaining a final pH of approximately 6.5.

General Procedure for Preparation of Blend Li-PAA/PAM Solutions

PAM (10 grams) was added to deionized water (90 grams) and the suspension was stirred and heated until fully dissolved in order to obtain a 10 wt. % solution. The 10 wt. % PAM solution (80 grams) was combined with the 10 wt. % Li-PAA solution (40 grams) to obtain the final binder solution for electrode fabrication.

Preparation of Electrode-Forming Compositions and Negative Electrodes

Electrode-forming compositions and negative electrodes were prepared as detailed below using the following equipment:
Mechanical mixer: planetary mixer (Speedmixer) and high shear mechanical mixer of the Dispermat® series with flat PTFE lightweight dispersion impeller;
Film coater/doctor blade: Elcometer® 4340 motorised/automatic film applicator;
Vacuum oven: BINDER APT line VD 53 with vacuum; and
Roll press: precision 4″ hot rolling press/calender up to 100° C.

### Example 1

An aqueous composition was prepared by mixing 28.0 g of a 10% by weight solution of Li-PAA/PAM, in water, 18.8 g of deionized water, 10.53 g of silicon oxide 42.11 g of graphite and 0.56 g of carbon black.

The mixture was homogenized by moderate stirring in planetary mixer for 10 min and then mixed again by moderate stirring for 1 h.

After about 1 h of mixing the shear is reduced and the slurry mixed again by low stirring for 1 h.

A negative electrode was obtained by casting the binder composition thus obtained on a 18.5 μm thick copper foil with a doctor blade and drying the coating layer in an oven at temperature of 90° C. for about 70 minutes. The thickness of the dried coating layer was about 70 μm. The electrode was then hot pressed at 60° C. in a roll press to achieve target density of 1.6 g/cc. The resulting negative electrode had the following composition: 18.8 wt. % of silicon oxide, 75.2 wt. % of graphite, 5 wt. % of Li-PAA/PAM and 1 wt. % of carbon black. Electrode E1 was thus obtained.

### Comparative Example: Negative Electrode Including Polyacrylic Acid (PAA) Only

An aqueous composition was prepared by mixing 27.5 g of a 10% by weight solution of Li-PAA, in water, 20.25 g of deionized water, 10.34 g of silicon oxide 41.36 g of graphite and 0.55 g of carbon black.

The mixture was homogenized by moderate stirring in planetary mixer for 10 min and then mixed again by moderate stirring for 1 h.

After about 1 h of mixing the shear is reduced and the slurry mixed again by low stirring for 1 h.

At the end of the stirring the slurry show severe precipitation and it was not possible to obtain an electrode CE1 with the following composition: 18.8 wt. % of silicon oxide, 75.2 wt. % of graphite, 5 wt. % of Li-PAA, and 1 wt. % of carbon black.

### Comparative Example: Negative Electrode Including Polyacrylic Acid (PAA) and Carboxymethyl Cellulose (CMC)

An aqueous composition was prepared by mixing 27.0 g of a 2% by weight solution of CMC in water, 21.6 g of a 10% by weight solution of Li-PAA, in water, 0.1 g of deionized water, 10.15 g of silicon oxide 40.61 g of graphite and 0.56 g of carbon black.

The mixture was homogenized by moderate stirring in planetary mixer for 10 min and then mixed again by moderate stirring for 1 h. After about 1 h of mixing the shear is reduced and the slurry mixed again by low stirring for 1 h.

A negative electrode was obtained by casting the binder composition thus obtained on a 18.5 μm thick copper foil with a doctor blade and drying the coating layer in an oven at temperature of 90° C. for about 70 minutes. The thickness of the dried coating layer was about 55 μm. The electrode was then hot pressed at 60° C. in a roll press to achieve target density of 1.6 g/cc. The resulting negative electrode had the following composition: 18.8 wt. % of silicon oxide, 75.2 wt. % of graphite, 4 wt. % of Li-PAA, 1 wt. % of CMC and 1 wt. % of carbon black. Electrode CE2 was thus obtained.

### Comparative Example: Negative Electrode Including Styrene-Butadiene Rubber (SBR) and Carboxymethyl Cellulose (CMC)

An aqueous composition was prepared by mixing 35.0 g of a 2% by weight solution of CMC, in water, 21.41 g of deionized water, 7.90 g of silicon oxide 31.58 g of graphite and 0.42 g of carbon black.

The mixture was homogenized by moderate stirring in planetary mixer for 10 min and then mixed again by moderate stirring for 1 h.

After about 1 h of mixing, 3.69 g of SBR suspension was added to the composition and mixed again by low stirring for 1 h.

A negative electrode was obtained by casting the binder composition thus obtained on a 18.5 μm thick copper foil with a doctor blade and drying the coating layer in an oven at temperature of 90° C. for about 70 minutes. The thickness of the dried coating layer was about 62 μm. The electrode was then hot pressed at 60° C. in a roll press to achieve target density of 1.6 g/cc. The resulting negative electrode had the following composition: 18.8 wt. % of silicon oxide, 75.2 wt. % of graphite, 3 wt. % of SBR, 2% of CMC and 1 wt. % of carbon black. Electrode CE3 was thus obtained.

Manufacture of Batteries

Coin cells (CR2032 type, 20 mm diameter) were prepared in a glove box under an Ar gas atmosphere by punching a small disk of the negative electrode prepared according to Examples 1, CE1, CE2 and CE3 together a balanced NMC positive electrode disk, purchased from CUSTOMCELLS. The electrolyte used in the preparation of the coin cells was a mixture of 1M LiPF₆ solution in EC/DMC 1/1 v/v with 2% wt VC and 10% wt F1EC, from Solvionic; polyethylene separators (commercially available from Tonen Chemical Corporation) were used as received.

Capacity Retention Testing

Full cell cycling stability at 1C C-rate (Open capacities were measured in triplicate and are shown in Table 1 below):

TABLE 1

| | Capacity | Capacity | Capacity | Capacity | Capacity |
|---|---|---|---|---|---|
| | retention | retention | retention | retention | retention |
| | after 1 | after 100 | after 200 | after 300 | after 400 |
| Binder | cycles | cycles | cycles | cycles | cycles |
| Example | (mAh/g) | (mAh/g) | (mAh/g) | (mAh/g) | (mAh/g) |
| E1 | 109 | 102 | 100 | 97 | 93 |
| CE1* | — | — | — | — | — |
| CE2 | 111 | 77 | 67 | 52 | 39 |
| CE3 | 100 | 74 | 66 | 60 | 56 |

*electrode not obtained due to poor rheology/sedimentation.

1. An aqueous electrode-forming composition [composition (C)] for use in the preparation of electrodes for electrochemical devices, characterized by comprising:
a) a binder composition [binder (B)] comprising:
aᵢ) at least one polyacrylamide (PAM) having a number average molecular weight (Mn) of at most 1600000 g/mol and
aᵢᵢ) at least one polyacrylic acid metal salt (PAA-Salt),
b) an electrode active material,
c) an aqueous solvent, and
d) optionally at least one electroconductivity-imparting additive.

2. The composition according to claim 1 wherein the total solid content of the composition (C) is comprised between 15 and 70 wt. % over the total weight of the composition (C).

3. The composition according to claim 1 wherein the amount of PAM to PAA-Salt is from about 3:1 to about 1:3 on a dry weight basis.

4. The composition according to claim 1 wherein the electrode active material comprises one or more carbon-based materials and/or one or more silicon-based materials.

5. The composition according to claim 4 wherein the carbon-based material is selected from at least one of graphite and graphene, and the silicon-based material is selected from at least one of silicon, alkoxysilane, aminosilane, silicon carbide and silicon oxide.

6. The composition according to claim 1 wherein the electroconductivity-imparting additive is carbon black.

7. The composition according to claim 1 wherein the at least one polyacrylic acid metal salt (PAA-Salt) is a lithium salt of PAA (Li-PAA).

8. A process for preparing an electrode [electrode (E)], said process comprising:
(i) providing a metal substrate having at least one surface;
(ii) providing the electrode-forming composition [composition (C)] according to claim 1;
(iii) applying the composition (C) provided in step (ii) onto the at least one surface of the metal substrate provided in step (i), thereby providing an assembly comprising a metal substrate coated with said composition (C) onto the at least one surface;
(iv) drying the assembly provided in step (iii);
(v) submitting the dried assembly obtained in step (iv) to a compression step.

9. An electrode [electrode (E)] obtained by the process according to claim 8.

10. The electrode [electrode (E)] according to claim 9 that is a negative electrode.

11. The electrode according to claim 10 which comprises, based on the total weight of the electrode:
0.5 to 15 wt. % of the binder (B),
45 to 95 wt % of the carbon-based material,
3 to 50 wt. % of the silicon-based material, and
0 to 5 wt. % of the electroconductivity-imparting additive.

12. An electrochemical device comprising at least one electrode (E) according to claim 9.

13. The electrochemical device according to claim 12, said electrochemical device being a secondary battery comprising:
a positive electrode and a negative electrode,
wherein at least one of the positive electrode and the negative electrode is the electrode (E) according to claim 9.

14. The electrochemical device according to claim 13, said electrochemical device being a secondary battery comprising:
a positive electrode and a negative electrode,
wherein the negative electrode is the electrode (E) according to claim 9.
